(19) United States
(12) Patent Application Publication
(10) Pub. No.: US 2009/0305545 A1
(43) Pub. Date: Dec. 10, 2009

(54) PROTECTION SYSTEM AND SOCKET THEREOF

(75) Inventor: Tsung-Yu Lin, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/471,484

(22) Filed: May 26, 2009

(30) Foreign Application Priority Data
Jun. 10, 2008 (CN) 200810302075.X

(51) Int. Cl. H01R 13/62

(52) U.S. Cl. 439/345

(57) ABSTRACT

A socket, comprising at least two insertion holes and a clasp device rotatably fastened on the socket. The clasp device comprises a clasp body, a cover, a bottom plate, and a connection body. The cover is positioned relative to the bottom plate, and the connection body is positioned between the cover and the bottom plate, wherein the cover, the bottom plate and the connection body define a receiving cavity.

### BACKGROUND

1. Technical Field

The disclosure is related to a plug and a socket, and particularly, to a protection device for a plug and a corresponding socket.

2. Description of Related Art

A plug is used to plug into a socket to provide electrical power to an electronic device. However, plugs may easily dislodge from sockets, and are easily exposed to environmental contamination. Furthermore, circuit interference, such as a short circuit or an open circuit may easily occur that may damage the electronic devices. Thus, what is needed is a protection device for a plug and a socket that secure the plug not to dislodge from the socket.

### BRIEF DESCRIPTION OF THE DRAWINGS

FIG. 1 is an exploded diagram of a plug and socket of a protection system as disclosed.

FIG. 2 shows a socket as disclosed, showing the socket and a plug in an unplugged state.

FIG. 3 shows a socket as disclosed, showing the socket and a plug in a plugged state.

### DETAILED DESCRIPTION

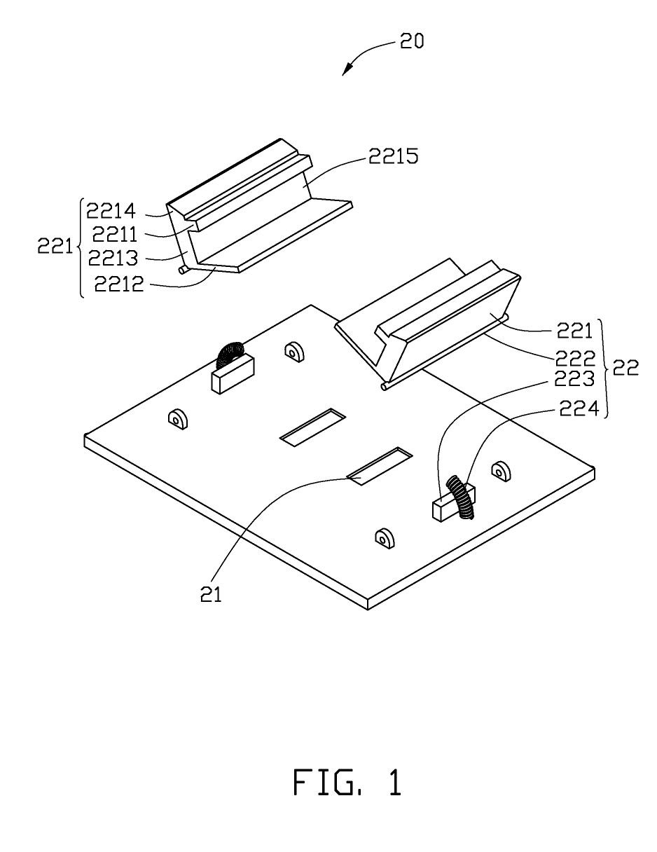

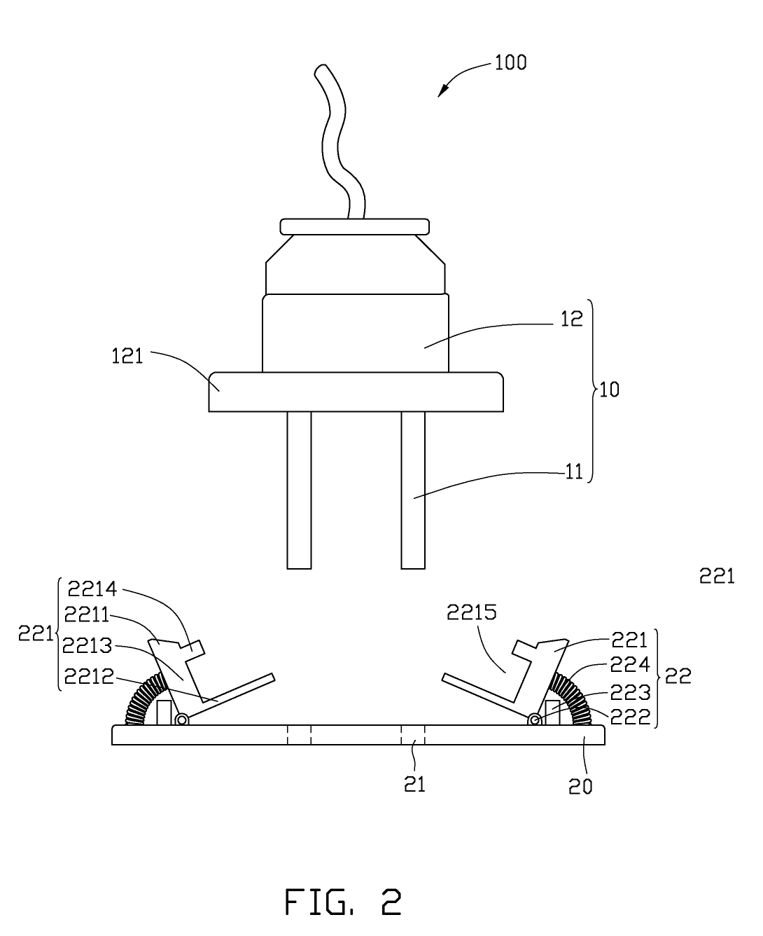

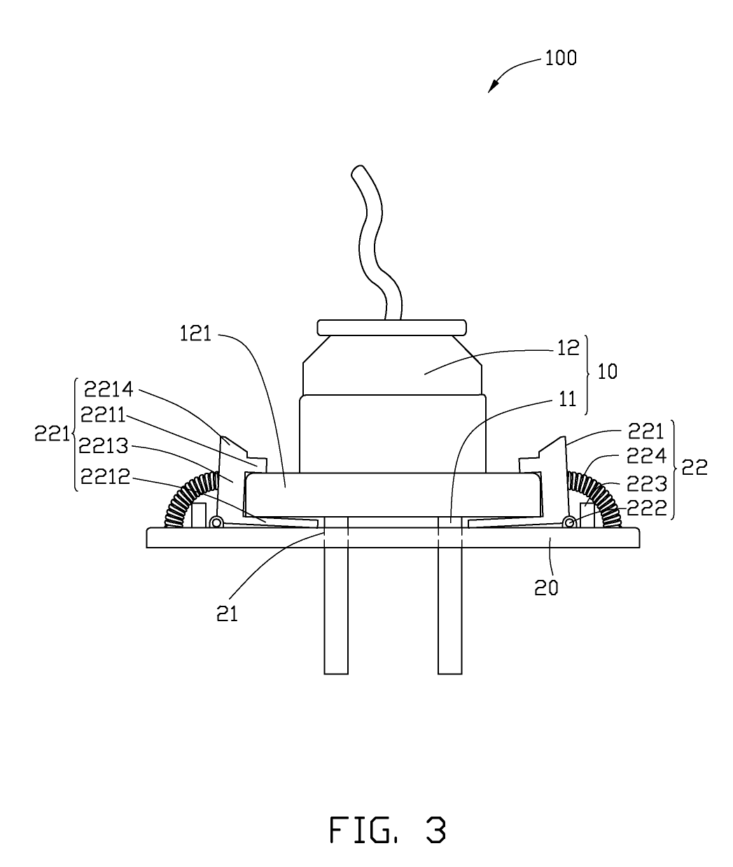

FIG. 1-3 show a protection device for a plug 10 and a socket 20 as disclosed. The plug 10 comprises two parallel pins 11 and a body 12. A flange 121 is provided in proximity to one end of the pin 11, which can be rectangular, annular, or other shape. In this embodiment, the flange is shown as a rectangle.

The socket 20 comprises two insertion holes 21 and two parallel clasp devices 22 rotatably fastened to the socket 20 outside the insertion holes 21. The number of insertion holes 21 corresponds to or exceeds the number of pins 11. The clasp device 22 comprises a clasp body 221, a rotation axle 222, a fastening post 223 and a spring 224.

The clasp body 221 comprises a cover 2211, a bottom plate 2212, a connection body 2213 provided between the cover 2211 and the bottom plate 2212, and an inclined plane 2214, where the cover 2211 and the bottom plate 2212 are parallel. The inclined plane 2214 is provided on the connection body 2213, in proximity to the cover 2211, at an angle increasing gradually from the cover 2211. The cover 2211, the bottom plate 2212 and the connection body 2213 define a receiving cavity 2215. When the pin 11 is received in the insertion holes 21, the clasp body 221 is configured to clasp the flange 121, and the flange 121 is received into the receiving cavity 2215.

The rotation axle 222 is rotatably fastened to the socket 20, and connected to the connection body 2213 and the bottom plate 2212. A post 223 is provided on the socket 20, in proximity to one side of the rotation axle 222 away from the plug 21. A spring 224 is configured for elevating the plug, wherein one end of the spring 224 is connected to the socket 20, and another end is connected to the clasp body 221. When the plug 10 is not received in the socket 20, the clasp body 221 is supported on the fastening post 223 by the retention force of the spring 224, and an angle is formed between the bottom plate and the socket 20 through the position of the post 223.

The flange 121 is received in the cavity 2215 and secured by the cover 2211 and the bottom plate 2212. Downward pressure on the inclined plane 2214 withdraws the plug 10, and the rotation axle 222 rotates to impel the clasp body 221 to elevate the flange 121p, and the plug 10 can be withdrawn.

The flange 121 is securely fastened in the receiving cavity 2215 by at least one clasp body 221 when the pin 11 of the plug 10 is received in the insertion holes 21.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A socket, comprising:
at least two insertion holes,
a clasp device rotatably fastened to the socket, comprising a clasp body, a cover, a bottom plate, and a connection body, the clasp body comprising a cover, a bottom plate, and a connection body provided between the cover and the bottom plate,
wherein the cover is positioned parallel to the bottom plate, and the connection body is positioned between the cover and the bottom plate,
and wherein the cover, the bottom plate and the connection body define a receiving cavity.

2. The socket as claimed in claim 1, wherein the clasp device is rotatably fastened to the socket by a rotation axle positioned between the connection body and the bottom plate.

3. The socket as claimed in claim 1, wherein the clasp device further comprises a fastening post positioned on one side of the socket, and a spring provided over the fastening post and connected to the socket and the clasp body.

4. The socket as claimed in claim 3, wherein the spring is a retaining spring.

5. The socket as claimed in claim 1, wherein the cover along one side of the connection body, away from the connection body, inclines away from the plug.

6. A protection system comprising a socket and a plug, the socket comprising at least two insertion holes and a clasp device rotatably fastened on the socket, comprising a clasp body, a cover, a bottom plate, and a connection body, wherein the cover is positioned relative to the bottom plate, and the connection body is positioned between the cover and the bottom plate, wherein the cover, the bottom plate and the connection body define a receiving cavity; and
the plug comprising at least two pins, a body fastening the at least two pins, a flange provided on one end in proximity to the pin, wherein the clasp device claps the flange when the pin is received in the through hole, and the flange is received into the receiving cavity.

7. The device as claimed in claim 6, wherein the flange is rectangularly-shaped.

8. The device as claimed in claim 6, wherein the flange is shaped as a ring.

9. The protection system as claimed in claim 6, wherein the number of clasp devices is two, distributed symmetrically on two sides of the plug.

10. The protection system as claimed in claim 6, wherein the clasp pin is positioned at the connection part of the connection body and the bottom plate by a pin.

11. The protection system as claimed in claim 10, wherein the clasp device comprises a fastening post and a spring, the fastening post positioned at one side of the connection body away from the through hole, and the two ends of the spring connects to the socket and the clasp body respectively.

12. The protection system as claimed in claim 6, wherein the clasp body comprises an inclined plane extending from one side of the cover away from the connection body, and the inclined plane inclines towards the through holes, and the cross-section of the inclined plane gradually declining towards the connection body.
